(19) United States
(12) Patent Application Publication
(10) Pub. No.: US 2026/0033660 A1
(43) Pub. Date: Feb. 5, 2026

(54) Hand Brew Coffee Filter with Adjustable Extraction Time

(71) Applicant: Lih Yeu Sheng Industries Co., Ltd., Tainan City (TW)

(72) Inventors: CHING TIEN HSU, Tainan City (TW); GENG-SHUO KUO, Tainan City (TW); SHIN-HUEI CHENG, Tainan City (TW)

(73) Assignee: Lih Yeu Seng Industries Co., Ltd., Tainan City (TW)

(21) Appl. No.: 19/183,959

(22) Filed: Apr. 21, 2025

(30) Foreign Application Priority Data
Jul. 31, 2024 (TW) 113128527

(51) Int. Cl. A47J 31/06; A47J 31/44

(52) U.S. Cl. CPC A47J 31/0615; A47J 31/446

(57) ABSTRACT

A hand brew coffee filter with adjustable extraction time includes a container body, a regulating rod, a guiding member, a supporting member, a filter screen, and a base. One end of the regulating rod is inserted through and coupled with the guiding member. The supporting member is mounted around the connecting section at the other end of the regulating rod. The filter screen is mounted around the connecting section and sits on the supporting member. The resulting regulating rod assembly is placed in the container body, before one end of the container body is put in the base to complete the coffee filter. The abutting surfaces between the container body and the guiding member and between the container body and the filter screen have absolute circularity and the same taper value so that the retention time of hot water in the coffee filter can be controlled through gap adjustment.

### RELATED APPLICATIONS

This application claims priority to Taiwan Patent Application No. 113128527 filed Jul. 31, 2024.

The above applications and all patents, patent applications, articles, books, specifications, other publications, documents, and things referenced herein are hereby incorporated herein in their entirety for all purposes. To the extent of any inconsistency or conflict in the definition or use of a term between any of the incorporated publications, documents, or things and the text of the present document, the definition or use of the term in the present document shall prevail.

### BACKGROUND OF THE INVENTION

### 1. Technical Field

The present invention relates to a hand brew coffee filter with adjustable extraction time. More particularly, the invention is directed to a filtering container for hand-brewing coffee, wherein the filtering container allows the time for which hot water stays in the ground coffee in the container during the brewing process to be adjusted according to the place of origin, the harvest season, and the post-harvest processing of the coffee beans from which the ground coffee is derived and the grind size of the ground coffee, in order to make coffee of different flavors, for it is well known in the art that the aroma, fat content, and mouthfeel of hand brew coffee can be changed by adjusting the retention time of hot water in ground coffee. The invention controls the retention time of hot water in ground coffee by precisely changing the size of the gap between a filter screen and a container body by way of screw threads.

### 2. Description of Related Art

Coffee nowadays can be made or brewed in many ways. For example, ready-made instant coffee granules can be bought and added directly with hot water to make a hot drink of the desired taste. Or, freshly ground coffee can be prepared by grinding coffee beans and then put into a paper filter placed in a brewing container, before brewing is carried out by manually pouring hot water over the ground coffee. Alternatively, freshly ground coffee obtained by grinding coffee beans may be put into a filtering container into which hot water is subsequently added and where high-temperature high-pressure extraction is performed to make the desired hot drink. Of the latter two brewing methods, hand brewing is the simpler in most cases and is regarded as the more effective method for extracting the essence of ground coffee. While the hand brewing method can be easily performed by putting ground coffee into a paper filter and pouring hot water directly onto the ground coffee, the required steadiness and duration of the output of hot water as well as the required temperature of the hot water are closely associated with the quality of the coffee beans being used. Certain coffee beans even require their grounds to be immersed for a short time in order to bring out their unique flavor.

In the high-temperature high-pressure extraction method, undesirable water-soluble substances may be mixed into the brewed coffee and thus impose a burden on a consumer's body. In addition, the aroma of freshly ground coffee may get lost during the high-temperature high-pressure extraction process as the coffee temperature lowers. Besides, hand-brewed coffee on the market is generally prepared with paper filters, which are used to hold ground coffee but tend to filter out the fatty aroma of freshly ground coffee as well, not to mention the environmental issues caused by used and discarded paper filters.

The inventor of the present invention intended to address the aforesaid problems of the hand brewing method, namely the environmental issues resulting from paper filters and issues related to controlling the steadiness and duration of the output of hot water. While water temperature can be precisely controlled with current technology, the time for which hot water should stay in ground coffee cannot be determined without a barista's multiple years of experience; in other words, the development of the ability to properly control the retention time of hot water is time-consuming. The invention helps control the coffee extraction time.

### BRIEF SUMMARY OF THE INVENTION

One embodiment of the present invention provides an improvement over the conventional filtering containers for use in brewing coffee so that not only can the brewed coffee be guided out smoothly, but also the extraction time of the brewing process, i.e., the brewing time of ground coffee, can be adjusted. More specifically, the invention discloses a hand brew coffee filter with adjustable extraction time, wherein the coffee filter includes a container body, a regulating rod, a guiding member, a supporting member, a filter screen, and a base. One end of the regulating rod forms an externally threaded regulating section that matches, and is configured to couple with, the internally threaded regulating hole of the guiding member. The regulating rod further has a connecting section, and a predetermined upper section of the connecting section matches, and is configured to be inserted through, the hole of the supporting member so that the supporting member is at a position where it can keep the filter screen away from the externally threaded regulating section of the regulating rod. The other end of the regulating rod is inserted through the hole of the filter screen until the filter screen sits on the upper side of the supporting member. Once the regulating rod, the guiding member, the supporting member, and the filter screen are sequentially put together as stated above, the resulting assembly is placed into the container body, and then one end of the container body is put into the base to complete the coffee filter. As the abutting surfaces between the container body and the guiding member and between the container body and the filter screen have absolute circularity and the same taper value, the width of the gap between the filter screen and the container body approaches zero when the filter screen and the container body are nested together and abut against each other. Therefore, once ground coffee is put into the filter screen, and hot water is poured on the ground coffee, the gap between the filter screen and the container body can be adjusted with precision using the regulating screw threads, thereby controlling the time for which the hot water stays in the ground coffee, and when the gap is enlarged, the brewed coffee can flow sequentially through the filter-screen through holes in the peripheral portion of the filter screen and the gap between the filter screen and the container body, before falling down through the guiding gaps between the guiding recesses in the outer periphery of the guiding member and the container body.

An objective of the present invention is to provide a hand brew coffee filter that has adjustable extraction time and can control the time for which hot water stays in the ground coffee in the coffee filter. The coffee filter includes a container body, a regulating rod, a guiding member, a supporting member, a filter screen, and a base. One end (hereinafter referred to as the first end) of the regulating rod forms an externally threaded regulating section. The opposite end (hereinafter referred to as the second end) of the regulating rod forms a connecting section that is slightly thinner than the externally threaded regulating section, and the top end of the connecting section is provided with a regulating notch to facilitate rotation, and hence regulation, of the regulating rod by a flat tool inserted into the regulating notch. The guiding member is centrally formed with an internally threaded regulating hole that is configured to couple with the externally threaded regulating section at the first end of the regulating rod, and by rotating the regulating rod, the externally threaded regulating section of the regulating rod can be vertically displaced in the internally threaded regulating hole of the guiding member. Also, the guiding member is provided with a plurality of longitudinal guiding recesses that are arranged at intervals along, and extend into, the outer periphery of the guiding member such that a guiding gap is formed between each guiding recess and an inner-side portion of the container body that spans a first predetermined section of the height of the container body, with the outer periphery of the guiding member abutting stably against the inner-side portion of the container body that spans the first predetermined section of the height of the container body. The supporting member is centrally penetrated by a hole that allows passage of the relatively thin connecting section at the second end of the regulating rod in order for the supporting member to end up at a position spaced apart from the externally threaded regulating section. The filter screen is centrally penetrated by a hole that allows passage of the relatively thin connecting section at the second end of the regulating rod, and the filter screen is configured to sit at the top end of the supporting member. In addition, the filter screen is provided with a plurality of filter-screen through holes that are in, and arranged at intervals along, a peripheral portion of the filter screen. The filter screen is so configured that a gap always exists between the filter screen and an inner-side portion of the container body that spans a second predetermined section of the height of the container body. Moreover, the abutting surfaces between the filter screen and the container body have absolute circularity and the same taper value so that the width of the gap between the filter screen and the container body can be made to approach zero. As stated above, when the regulating notch is rotated, the externally threaded regulating section of the regulating rod will be moved in the internally threaded regulating hole of the guiding member, and the supporting member will be driven at the same time to displace the filter screen upward or downward, thereby enlarging or reducing the gap between the filter screen and the container body. The container body is a component that has an open top and an open bottom and that serves containing/holding purposes. Once sequentially put together, the regulating rod, the guiding member, the supporting member, and the filter screen can be placed into the container body. The base is centrally formed with a sunken region, and a lower section of the container body can be placed in the sunken region such that the container body and the base jointly form the hand brew coffee filter along with the regulating rod, the guiding member, the supporting member, and the filter screen placed in the container body. Once ground coffee is put in the filter screen, and hot water is poured over the ground coffee, the brewed coffee can flow sequentially through the filter-screen through holes in the peripheral portion of the filter screen and the gap between the filter screen and the container body and then fall down through the guiding gaps between the guiding recesses in the outer periphery of the guiding member and the container body. A flat tool can be used to rotate the regulating notch of the regulating rod in order for the externally threaded regulating section and the internally threaded regulating hole to work together and make a precise adjustment, i.e., precisely enlarge or reduce, the gap between the filter screen and the container body, thereby enabling the hand brew coffee filter to have adjustable extraction time.

An objective of the present invention is for the abutting surfaces between the container body and the guiding member of the coffee filter to have absolute circularity, the same taper value, and a downwardly tapered configuration, and for the guiding recesses of the guiding member to increase friction with the container body, thereby helping the guiding member abut stably against the inner-side portion of the container body that spans the first predetermined section of the height of the container body.

An objective of the present invention is for the abutting surfaces between the filter screen and the container body of the coffee filter to have absolute circularity and the same taper value so that when reduced to the greatest extent, the width of the gap between the filter screen and the container body approaches zero to close the filter-screen through holes completely.

An objective of the present invention is for the regulating rod to have the regulating notch, which extends into the upper end of the regulating rod, so that a flat tool inserted into the regulating notch can be used to rotate the regulating rod and thereby move the supporting member and the filter screen upward or downward to adjust, i.e., to enlarge or reduce, the gap between the filter screen and the inner side of the container body.

### BRIEF DESCRIPTION OF THE SEVERAL VIEWS OF THE DRAWINGS

FIG. 1 is an exploded perspective view of the coffee filter of the present invention, showing its components separately.

FIG. 2 is an exploded sectional view of the coffee filter of the present invention.

FIG. 3 is an assembled perspective view of the coffee filter of the present invention.

FIG. 4 shows a downward adjustment in the coffee filter of the present invention to close the gap between the filter screen and the container body.

FIG. 5 shows an upward adjustment in the coffee filter of the present invention to open the gap between the filter screen and the container body.

### DETAILED DESCRIPTION OF THE INVENTION

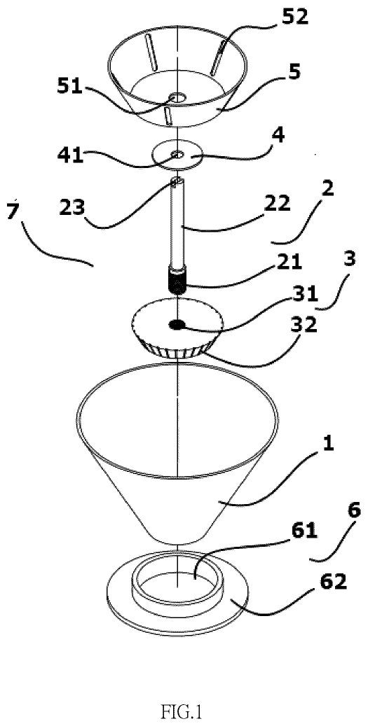

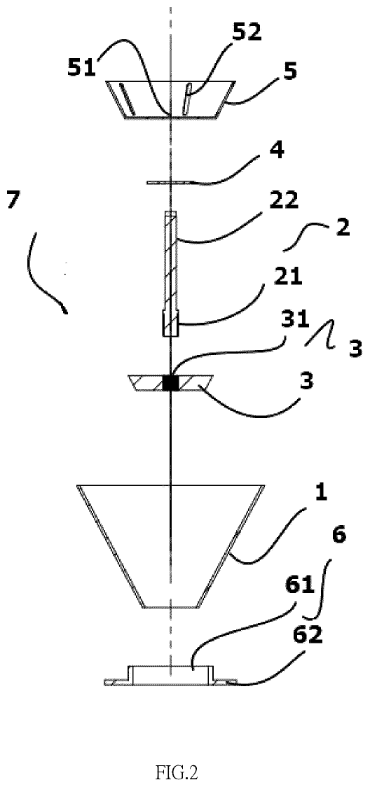

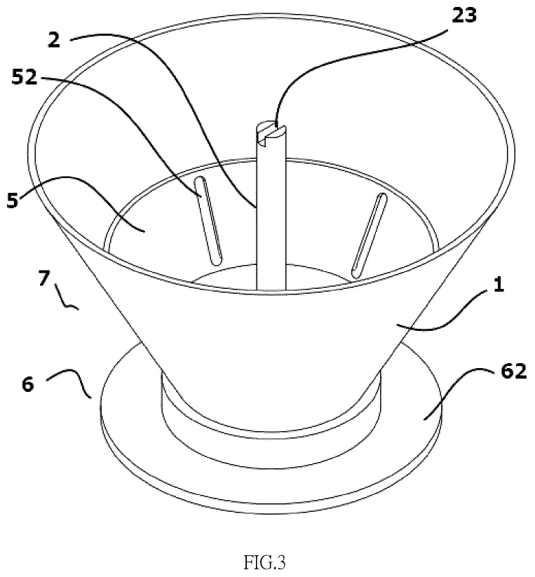

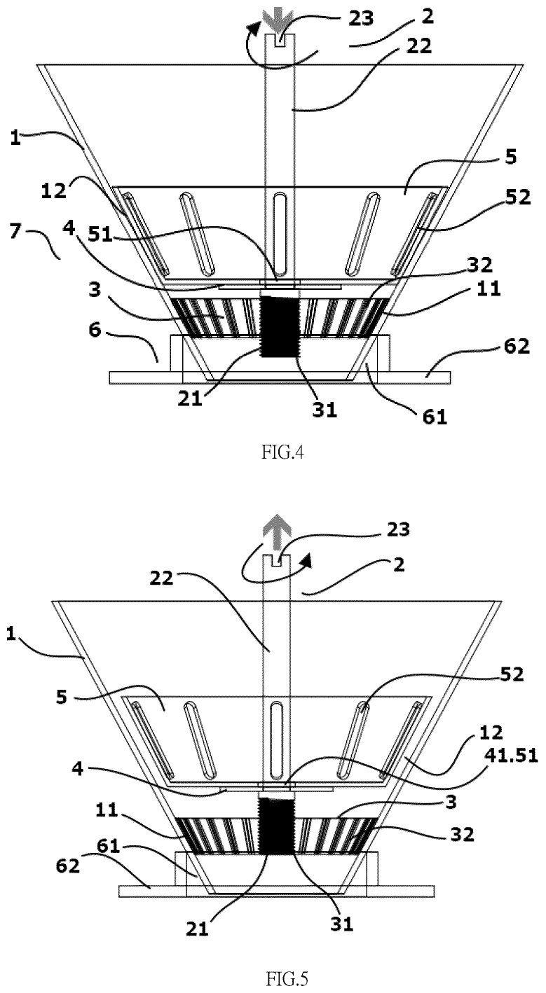

One embodiment of the present invention provides a hand brew coffee filter that has adjustable extraction time. Referring to FIG. 1 to FIG. 5, the coffee filter includes a container body 1, a regulating rod 2, a guiding member 3, a supporting member 4, a filter screen 5, and a base 6. One end (hereinafter referred to as the first end) of the regulating rod 2 forms an externally threaded regulating section 21, and the other end (hereinafter referred to as the second end) of the regulating rod 2 is a connecting section 22 slightly thinner than the externally threaded regulating section 21. The guiding member 3 is centrally formed with an internally threaded regulating hole 31 that allows passage of, and is configured to couple with, the externally threaded regulating section 21 at the first end of the regulating rod 2. A plurality of longitudinal guiding recesses 32 are arranged at intervals along, and extend into, the outer periphery of the guiding member 3 such that a guiding gap 11 is formed between each guiding recess 32 and an inner-side portion of the container body 1 that spans a first predetermined section of the height of the container body 1 (see FIG. 4 and FIG. 5). The abutting surfaces between the outer periphery of the guiding member 3 and the inner-side portion of the container body 1 that spans the first predetermined section of the height of the container body 1 have absolute circularity and the same taper value and can therefore abut stably against each other. The supporting member 4 is centrally penetrated by a hole 41 that allows passage of the relatively thin connecting section 22 at the second end of the regulating rod 2 in order for the supporting member 4 to end up at a position spaced part from the externally threaded regulating section 21 (see FIG. 4 and FIG. 5). The filter screen 5 is centrally penetrated by a hole 51 that allows passage of the relatively thin connecting section 22 at the second end of the regulating rod 2, and the filter screen 5 is configured to sit at the top end of the supporting member 4 (see FIG. 4 and FIG. 5). A plurality of filter-screen through holes 52 are provided in, and arranged at intervals along, the peripheral portion of the filter screen 5, and it is required that the abutting surfaces between the filter screen 5 and an inner-side portion of the container body 1 that spans a second predetermined section of the height of the container body 1 have absolute circularity and the same taper value so as to maintain a gap 12 between the filter screen 5 and the container body 1 (see FIG. 4 and FIG. 5). The container body 1 is a component with an open top and an open bottom and serves containing/holding purposes so that an assembly formed of the regulating rod 2, the guiding member 3, the supporting member 4, and the filter screen 5 can be placed into the container body 1. As the abutting surfaces between the container body 1 and the guiding member 3 and between the container body 1 the filter screen 5 have absolute circularity and the same taper value, the width of the gap 12 between the container body 1 and the filter screen 5 approaches zero when the container body 1 and the filter screen 5 are nested together and abut against each other. Once ground coffee is put into the filter screen 5 and added with hot water, the regulating notch 23 can be rotated to move the externally threaded regulating section 21 of the regulating rod 2 in the internally threaded regulating hole 31 of the guiding member 3 (as the abutting surfaces between the guiding member 3 and the container body 1 have absolute circularity and the same taper value, and the guiding recesses 32 provide a certain amount of friction, rotation of the regulating rod 2 will not cause rotation of the guiding member 3), thereby displacing the supporting member 4 and the filter screen 5 upward or downward, the objective being to enlarge or reduce the gap 12 between the filter screen 5 and the container body 1 and to allow the brewed coffee to flow out through the filter-screen through holes 52 in the peripheral portion of the filter screen 5, fall down through the gap 12 between the filter screen 5 and the container body 1 (see FIG. 4 and FIG. 5), and then be guided out through the guiding recesses 32 in the outer periphery of the guiding member 3. The base 6 is centrally formed with a sunken region 61, and a lower section of the container body 1 can be placed into the sunken region 61 such that all the foregoing components jointly form a coffee filter 7 (see FIG. 3) that allows the brewed coffee liquid to flow sequentially through the filter-screen through holes 52 in the peripheral portion of the filter screen 5 and the gap 12 between the filter screen 5 and the container body 1 and then fall down through the guiding gaps 11 between the guiding recesses 32 in the outer periphery of the guiding member 3 and the container body 1. The coffee filter 7 constitutes a hand brew coffee filter with adjustable extraction time because by rotating the regulating notch 23 of the regulating rod 2, the externally threaded regulating section 21 can be driven to move the supporting member 4 and the filter screen 5 upward or downward, thereby adjusting, i.e., enlarging or reducing, the gap 12 between the filter screen 5 and the container body 1.

In the aforesaid hand brew coffee filter with adjustable extraction time (i.e., the coffee filter 7), the container body 1 is a conical component that tapers downward (as shown in FIG. 4) to make it easy to put the guiding member 3 and the filter screen 5, both of which have absolute circularity and the same taper value as the container body 1, into the container body 1.

In the aforesaid hand brew coffee filter with adjustable extraction time (i.e., the coffee filter 7), the guiding member 3 and the container body 1 have matching downwardly tapered configurations, the abutting surfaces between the guiding member 3 and the container body 1 have absolute circularity and the same taper value, and the guiding recesses 32 provide a certain amount of friction. Therefore, rotation of the regulating rod 2 will not cause the guiding member 3 to rotate along with the regulating rod 2; that is to say, the guiding member 3 will abut stably against the inner-side portion of the container body 1 that spans the first predetermined section of the height of the container body 1, without rotating along with the rotated regulating rod 2 (see FIG. 4 and FIG. 5).

In the aforesaid hand brew coffee filter with adjustable extraction time (i.e., the coffee filter 7), the entire periphery of the supporting member 4 must be able to hold up the bottom portion of the filter screen 5 (see FIG. 4 and FIG. 5).

In the aforesaid hand brew coffee filter with adjustable extraction time (i.e., the coffee filter 7), the outer periphery of the filter screen 5 has a downwardly tapered configuration matching that of the container body 1 in order to maintain the gap 12 between the filter screen 5 and the inner-side portion of the container body 1 that spans the second predetermined section of the height of the container body 1. Moreover, as the abutting surfaces between the filter screen 5 and the container body 1 have absolute circularity and the same taper value, the width of the gap 12 can approach zero when reduced to the greatest extent, thereby closing the filter-screen through holes 52 completely (see FIG. 4).

In the aforesaid hand brew coffee filter with adjustable extraction time (i.e., the coffee filter 7), the base 6 has a lower section extending outward to form a placement section 62 to be placed at the top end of a predetermined container for holding the hot brewed beverage prepared with the coffee filter 7 (see FIG. 3).

In the aforesaid hand brew coffee filter with adjustable extraction time (i.e., the coffee filter 7), the regulating notch 23 (see FIG. 4) extending into the upper end of the regulating rod 2 is so configured that a flat tool can be inserted into the regulating notch 23 and then used to rotate the regulating rod 2, thereby moving the filter screen 5 upward or downward to adjust, i.e., to enlarge or reduce, the gap 12 between the filter screen 5 and the inner side of the container body 1 (see FIG. 4 and FIG. 5).

In the aforesaid hand brew coffee filter with adjustable extraction time (i.e., the coffee filter 7), it is preferable that the container body 1, the regulating rod 2, the guiding member 3, the supporting member 4, and the filter screen 5 are made of metal.

What is claimed is:

1. A hand brew coffee filter with adjustable extraction time, comprising:
a container body;
a regulating rod;
a guiding member;
a supporting member;
a filter screen; and
a base;
wherein the regulating rod has a first end forming an externally threaded regulating section and an opposite second end forming a connecting section slightly thinner than the externally threaded regulating section;
wherein the guiding member is centrally formed with an internally threaded regulating hole, the internally threaded regulating hole allows passage of, and is configured to couple with, the externally threaded regulating section at the first end of the regulating rod, and the guiding member is provided with a plurality of longitudinal guiding recesses arranged at intervals along, and extending into, an outer periphery of the guiding member such that a guiding gap is formed between each said guiding recess and an inner-side portion of the container body that spans a first predetermined section of a height of the container body, with the outer periphery of the guiding member and the inner-side portion of the container body that spans the first predetermined section of the height of the container body abutting stably against each other;
wherein the supporting member is centrally penetrated by a hole configured to allow passage of the connecting section at the second end of the regulating rod in order for the supporting member to end up at a position spaced apart from the externally threaded regulating section;
wherein the filter screen is centrally penetrated by a hole configured to allow passage of the connecting section at the second end of the regulating rod, is configured to sit at a top end of the supporting member, is provided with a plurality of filter-screen through holes in, and arranged at intervals along, a peripheral portion of the filter screen, and is configured to maintain a gap between the filter screen and an inner-side portion of the container body that spans a second predetermined section of the height of the container body;
wherein the container body is a component having an open top and an open bottom such that, once put together, the guiding member, the regulating rod, the supporting member, and the filter screen are capable of being placed in the container body; and
wherein the base is centrally formed with a sunken region, and a lower section of the container body is configured to be placed in the sunken region such the container body and the base jointly form the hand brew coffee filter together with the guiding member, the regulating rod, the supporting member, and the filter screen placed in the container body.

2. The hand brew coffee filter with adjustable extraction time as claimed in claim 1, wherein an entire periphery of the supporting member is able to hold up a bottom portion of the filter screen.

3. The hand brew coffee filter with adjustable extraction time as claimed in claim 1, wherein abutting surfaces between the container body and the guiding member and between the container body and the filter screen have absolute circularity and a same taper value and are downwardly tapered.

4. The hand brew coffee filter with adjustable extraction time as claimed in claim 1, wherein the base has a lower section extending outward to form a placement section.

5. The hand brew coffee filter with adjustable extraction time as claimed in claim 1, wherein the regulating rod is provided with a regulating notch extending into an upper end of the regulating rod.

6. The hand brew coffee filter with adjustable extraction time as claimed in claim 1, wherein the container body, the regulating rod, the guiding member, the supporting member, and the filter screen are made of metal.
